(19) United States
(12) Patent Application Publication
(10) Pub. No.: US 2010/0252959 A1
(43) Pub. Date: Oct. 7, 2010

(54) METHOD FOR IMPROVED BRITTLE MATERIALS PROCESSING

(75) Inventors: Weisheng Lei, San Jose, CA (US); Glenn Simenson, Tigard, OR (US); Hisashi Matsumoto, Hillsboro, OR (US); Guangyu Li, Portland, OR (US); Jeffrey Howerton, Portland, OR (US)

Correspondence Address: ELECTRO SCIENTIFIC INDUSTRIES, INC., 13900 N.W. SCIENCE PARK DRIVE, PORTLAND, OR, 97229, US

(73) Assignee: Electro Scientific Industries, Inc., Portland, OR (US)

(21) Appl. No.: 12/732,020

(22) Filed: Mar. 25, 2010

Related U.S. Application Data
(60) Provisional application No. 61/164,162, filed on Mar. 27, 2009.

(51) Int. Cl. B44C 1/22; B29C 35/08

(52) U.S. Cl. 264/400

(57) ABSTRACT

An improved method for laser machining features in brittle materials such as glass is presented, wherein a tool path related to a feature is analyzed to determine how many passes are required to laser machine the feature using non-adjacent laser pulses. Laser pulses applied during subsequent passes are located so as to overlap previous laser spot locations by a predetermined overlap amount. In this way no single spot receives excessive laser radiation caused by immediately subsequent laser pulses being applied adjacent to a previous pulse location.

This patent application claims benefit of U.S. Provisional Application No. 61/164,162, filed Mar. 27, 2009.

### TECHNICAL FIELD

The present invention regards methods for laser processing of brittle materials such as glass. In more particular it regards methods for laser machining features in glass or like materials while avoiding stress fractures and chipping and maintaining acceptable system throughput.

### BACKGROUND OF THE INVENTION

Glass cutting has been traditionally realized by using mechanical saws, which scribes the glass and follow with a mechanical breaking step. In recent years, laser technology has been adopted for glass cutting, which generally uses laser as a localized heating source, either accompanied by a cooling nozzle or not, to generate stress and micro cracks along the trajectories to cut the glass. Such resultant stress and micro cracks either may be sufficient enough to cause the glass fracture and separate along the designed trajectories or may require a subsequent breaking step to separate the glass. Existing technologies utilizing laser only without a cooling source include, but are not limited to MLBA (Multiple Laser Beam Absorption) as described in US patent application no. 2007/0039932 DEVICE FOR SEPARTIVE MACHINING OF COMPONENTS MADE FROM BRITTLE MATERIAL WITH STRESS-FREE COMPONENT MOUNTING, inventors Michael Haase and Oliver Haupt. Feb. 22, 2007 and US patent application no. 2007/0170162 METHOD AND DEVICE FOR CUTTING THROUGH SEMICONDUCTOR MATERIALS, inventors Oliver Haupt and Bernd Lange, Jul. 26, 2007, which uses a near IR laser source in combination with a pair of reflective mirrors to maximize the volume absorption of photon energy in the glass along the path to be separated so that there will be sufficient thermal stress generated as to break the parts without need to apply additional force. This technology, however, does require a initial mechanical notch to function as a pre-crack. The laser generated stress will make the initial crack propagate to form the separation. ZWLDT®: Zero-Width Laser Dicing Technology® by Fonon Technology International, Lake Mary, Fla. 32746, uses a CO₂ source to heat the glass following with a cooling nozzle to generate stress as to initiate micro cracks along the cutting path then apply a mechanical breaking step to separate the glass. All these afore-cited approaches are very difficult to apply to the situation in which the trajectories involve round corners or curved path due to the difficulty in precisely controlling the direction of crack propagation, since there is almost zero kerf width associated with these processes. Even applying a mechanical breaking step it is still very difficult to precisely separate the parts without causing significant chipping or cracking from bulk glass.

What is required then is a method for cutting brittle materials such as glass with trajectories involving round corners or curved segments with a laser at acceptable rates without causing unacceptable chipping and cracking.

### SUMMARY OF THE INVENTION

An aspect of the instant invention is a method for laser machining complex trajectories in brittle materials such as glass that avoids chipping and cracking in the material associated with excessive heat build up in the region surrounding the feature without requiring expensive additional equipment or causing a significant reduction if system throughput. Excessive heat build up in the region can be avoided by spacing the laser pulses as the feature is being machined so that succeeding laser pulses do not overlap upon the same location as the previous pulse. An embodiment of the instant invention analyzes the tool path associated with a feature to determine how many passes would be required to laser machine the feature into a workpiece given a desired pulse overlap and step size. A tool path is a series of locations on a workpiece that indicate where a laser pulses are to be directed in order to machine the associated feature. A feature may have multiple possible tool paths depending upon the laser parameters used and still create the same feature. This embodiment directs one or more laser pulses to a selected point on the tool path. Then, rather than moving the laser a fraction of a focal spot distance and directing another pulse to the workpiece to achieve the desired overlap, the system steps over a calculated number of potential pulse locations on the tool path and then directs a laser pulse to the workpiece. The system then continues down the tool path, directing laser pulses to the workpiece separated by a calculated number of potential pulse locations until the tool path is exhausted. The system then starts over, directing a laser pulse to the workpiece in a location offset from the first laser pulse location by a fraction of a laser pulse spot distance, thereby achieving pulse overlap without causing excessive heating. The system then indexes by the calculated step size to the next location, which overlaps the next previous laser pulse location by the same overlap offset. The process continues until the entire feature is machined.

To achieve the foregoing and other objects in accordance with the purposes of the present invention, as embodied and broadly described herein, a method and apparatus is disclosed.

### BRIEF DESCRIPTION OF THE DRAWINGS

FIG. 1 Tool path with one pass of laser processing.

FIG. 2 Tool path with five passes of laser processing.

FIG. 3 Tool path showing completed laser processing.

### DETAILED DESCRIPTION OF PREFERRED EMBODIMENTS

An embodiment of this invention is an improved method for laser machining a feature in brittle material with a laser processing system. This laser processing system has a tool path, or a series of locations on a workpiece that indicate where a laser pulses are to be directed in order to machine the associated feature. An exemplary laser processing system which may be adapted to embody this invention is the MM5800 manufactured by Electro Scientific Industries, Inc., Portland, Oreg. 97229. This system uses two lasers, one or both of which may be a diode-pumped solid state Q-switched Nd:YAG, or Nd:YVO4 laser operating at wavelengths from about 1064 microns down to about 255 microns at pulse repetition frequencies of between 30 and 70 KHz and having average power of greater than about 5.7 W at 30 KHz pulse repetition rate.

Embodiments of this invention represent new applications of techniques disclosed in U.S. Pat. No. 7,259,354 METHODS FOR PROCESSING HOLES BY MOVING PRECISELY TIME LASER PULSES IN CIRCULAR AND SPIRAL TRAJECTORIES, inventors Robert M. Pailthorp, Weisheng Lei, Hisashi Matsumoto, Glenn Simonson, David A. Watt, Mark A. Unrath, and William J. Jordens, Aug. 21, 2007, which is included in its entirety herein by reference, wherein holes are drilled in materials using a laser beam spot size smaller than the hole being drilled, requiring the laser pulses to be moved in a circular or spiral tool path. It was demonstrated that spacing the laser pulses around the circumference of the circle provided better quality holes. This invention is an extension of this disclosure, wherein the quality and throughput of laser machining brittle materials can be increased by calculating the spacing and timing of laser pulses applied to an arbitrary tool path on a brittle workpiece. By spacing the laser pulses from each other in both time an space along the tool path as a feature is machined, excessive heat build up in any particular area is avoided, thereby increasing the quality of the cut. By pulsing the laser according to embodiments of this invention, the location pulsed will be allowed to cool before an adjacent location is pulsed, thereby allowing the laser pulses to be maximize the amount of material removed per pulse without having to worry about residual damage. This permits the entire process to be optimized to increase throughput while maintaining quality.

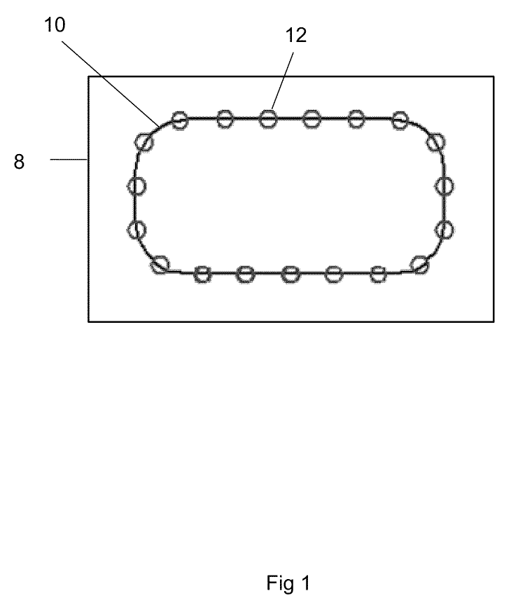

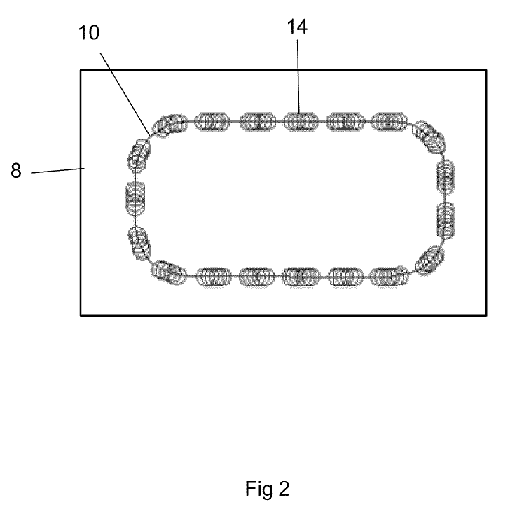

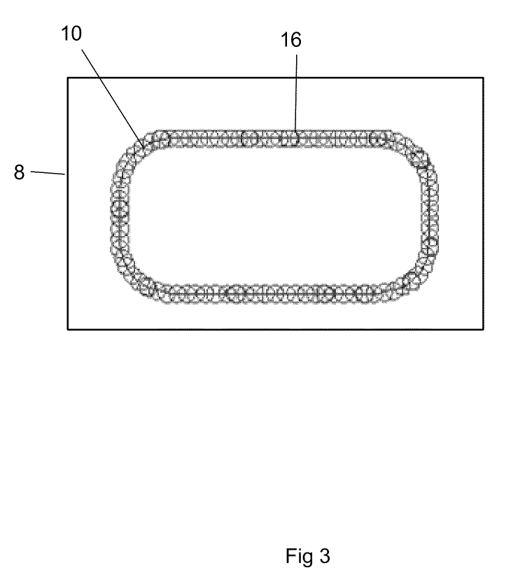

An aspect of this invention is illustrated in FIG. 1, where a complex tool path 10 on a workpiece 8 is shown. This tool path contains curved sections which are difficult to cut without causing cracking and chipping. The circles, one of which is indicated 12, represent laser pulses directed to the workpiece in one pass. Once this pass was complete, the pattern would be indexed one step size and repeated. FIG. 2 shows this pattern of pulses 14 on a tool path 10 on a workpiece 8 after five passes. FIG. 3 shows the laser pulses 16 have completely machined the feature described by the tool path 10 on the workpiece 8.

In laser via drilling applications, when a trepan tool is drilled with multiple repetitions at the perimeter, it is desired to fine tune the scan speed and rep-rate such that pulses are evenly distributed around the perimeter of the hole, in order to achieve uniform material removal and get better via-to-via consistency in terms of via quality. The position increments between pulses should be equal and minimized. A new quantity is defined, the imaginary bite size, which is the distance along the perimeter between the first pulse delivered in the 1st revolution, and the first pulse delivered in the 2nd revolution. An algorithm is specified which tweaks tool velocity to set the imaginary bite size to optimize the pulse spacing to be even and as finely distributed as possible. It is also a method for timing the Q switched laser commands to synchronize all pulses with the timing required by the intended tool path.

It will be apparent to those of ordinary skill in the art that many changes may be made to the details of the above-described embodiments of this invention without departing from the underlying principles thereof. The scope of the present invention should, therefore, be determined only by the following claims.

We claim:

1. An improved method for laser machining a feature in brittle material with a laser processing system said laser processing system having a tool path, comprising:
providing a laser having laser pulses and laser pulse parameters operative to laser machine said brittle material;
calculating a said laser pulse parameters based on said tool path wherein the number and locations of each laser pulse are calculated to provide predetermined pulse overlap and timing for each location on the tool path; and
directing said laser to emit said laser pulses to impinge upon said brittle material according to said calculated laser pulse parameters, thereby machining said feature in said brittle material.

2. The method of claim 1 wherein said predetermined pulse overlap and timing are selected to provide spacing between said laser pulses.

3. The method of claim 1 wherein said laser parameters include pulse repetition rate, scan speed, spot size, bite size and number of passes.

4. The method of claim 2 wherein said pulse repetition rate is between about 1 KHz and 1 MHz.

5. The method of claim 2 wherein said scan speed is between about 100 mm/s and 5000 mm/s.

6. The method of claim 2 wherein said spot size is between about 10 microns and 500 microns.

7. The method of claim 2 wherein said bite size is between about 10 microns and 500 microns.

8. The method of claim 2 wherein said number of passes is between about 1 and about 100.
